(19) United States
(12) Patent Application Publication
(10) Pub. No.: US 2013/0026430 A1
(43) Pub. Date: Jan. 31, 2013

(54) TIGHTENING DEVICE AND MANUAL FORK TRUCK USING THE SAME

(71) Applicants: CHEN-HSING CHENG, Tu-Cheng (TW); TSUNG-YU HUNG, Tu-Cheng (TW); HSING-YI HU, Tu-Cheng (TW)

(72) Inventors: CHEN-HSING CHENG, Tu-Cheng (TW); TSUNG-YU HUNG, Tu-Cheng (TW); HSING-YI HU, Tu-Cheng (TW)

(73) Assignee: HON HAI PRECISION INDUSTRY CO., LTD., New Taipei (TW)

(21) Appl. No.: 13/304,397

(22) Filed: Nov. 24, 2011

(30) Foreign Application Priority Data
Jul. 26, 2011 (TW) 100126263

(51) Int. Cl. B62B 3/06; B65D 63/00; B66F 9/065; B60P 7/06

(52) U.S. Cl. 254/2 R; 410/103

(57) ABSTRACT

A manual fork truck using a tightening device is disclosed. The tightening device applied to a manual fork truck, comprises a tightening rod; a fixing portion on one end of the tightening rod; and a plurality of tightening assemblies separately assembled to the tightening rod axially; each of the plurality of tightening assemblies comprising at least one tightening arm on the tightening rod, and a tightening belt having one end connected to the at least one tightening arm.

### BACKGROUND

1. Technical Field

This disclosure relates to tightening devices, and particularly, to a tightening device and a manual fork truck using the tightening device.

2. Description of Related Art

Manual fork trucks are widely used for lifting and transporting goods. Goods are put directly on the pallet fork of the manual fork truck, and may fall off the pallet fork. Thus, an extra tightening device is often mounted to the manual fork truck to tightly hold and secure the goods, thereby preventing the goods from falling off the pallet fork during the lifting and transporting process.

However, known tightening devices are bulky and may have complex structures taking up relatively large spaces, and may not tighten the goods well.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the present disclosure. Moreover, in the drawings like reference numerals designate corresponding parts throughout the several views. Wherever possible, the same reference numerals are used throughout the drawings to refer to the same or like elements of an embodiment.

FIG. 1 shows an isometric view of an embodiment of a manual fork truck employing a first embodiment of a tightening device.

FIG. 2 shows an isometric view of a second embodiment of the tightening device.

FIG. 3 shows an isometric view of another embodiment of a tightening assembly of the tightening device in a manual fork truck.

### DETAILED DESCRIPTION

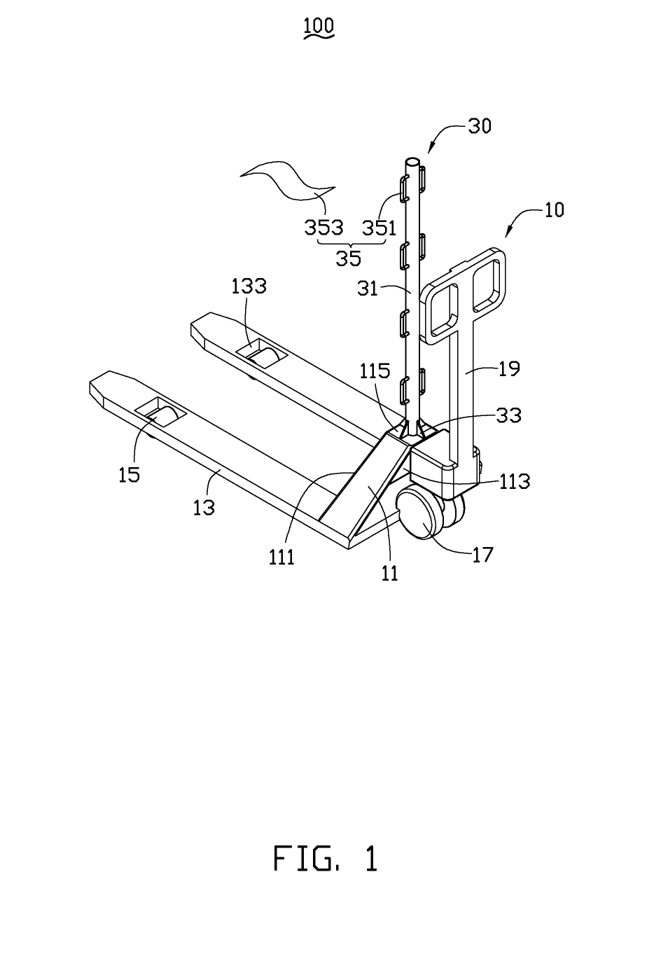

Referring to FIG. 1, an embodiment of a manual fork truck 100 comprises a truck body 10, and a tightening device 30 mounted on the truck body 10. The tightening device 30 tightly holds and secures goods on the truck body 10. The truck body 10 comprises a base bracket 11, two pallet forks 13, two load wheels 15, a guide wheel 17, and an operating pusher 19.

The base bracket 11 is a substantially trapezoidal shaped base, and comprises a first end 111 which is substantially trapezoidal shaped, a second end 113 opposite and parallel to the first end 111, and a top surface 115 interconnecting the first end 111 and the second end 113.

The two pallet forks 13 are substantially rectangular board shaped. The tow pallet forks 13 are separately mounted to the first end 111 of the base bracket 11, and positioned adjacent to a bottom portion of the base bracket 11. The two pallet forks 13 cooperatively form a carrying space (not labeled) together with the base bracket 11, for loading goods (not shown). Each of the two pallet forks 13 defines a mounting hole 133 adjacent to a distal end of each of the two pallet forks 13, away from the base bracket 11. The mounting hole is substantially rectangular shaped. In an alternative embodiment, the mounting hole 133 may be a mounting slot recessed from a bottom surface of the pallet fork 13, away from the base bracket 11. The mounting slot partially receives each of the two load wheels 15.

Each of the two load wheels 15 is oppositely mounted to a bottom portion of each of the two pallet forks 13, and partially received within the mounting hole 133.

The guide wheel 17 is rotatably and adjustably mounted to the second end 113 of the base bracket 11, adjacent to a substantially middle portion of the bottom portion of the base bracket 11. A direction of the guide wheel 17 can be adjusted for guiding and adjusting directions of the truck body 10.

The operating pusher 19 is adjustably hinged to the second end 113 of the base bracket 11, adjacent to and above the guide wheel 17, for being handled by an operator during use.

The tightening device 30 is mounted on the top surface 115 of the base bracket 11. The tightening device 30 tightly holds and secures goods on the pallet forks 13 of the truck body 10. The tightening device 30 comprises a tightening rod 31, a fixing portion 33 on one end of the tightening rod 31, and a plurality of tightening assemblies 35 separately and axially assembled to the tightening rod 31. In the illustrated embodiment, the tightening rod 31 is a hollow cylindrical post made of metallic material. The fixing portion 33 comprises a plurality of strengthening rib sheets projecting radially from an outer periphery of the distal end of the tightening rod 31. The plurality of strengthening rib sheets are substantially triangular shaped, and configured to facilitate fastening the tightening rod 31 with the top surface 115 of the base bracket 11. The fixing portion 33 is fixedly welded to the top surface 115 of the base bracket 11 in one embodiment.

Each of the plurality of tightening assemblies 35 comprises at least one tightening arm 351, and a tightening belt 353. In the illustrated embodiment, each of the plurality of tightening assemblies 35 comprises two tightening arms 351 symmetrically projecting from the outer periphery of the tightening rod 31, and a tightening belt 353. Each of the two tightening arms 351 is substantially U-shapes. The tightening belt 353 has one end connected to one of the two tightening arms 351, and one free end.

As in use, the goods are put on the two pallet forks 13 and received within the carrying space of the manual fork truck 100, the free end of the tightening belt 353 tightly surrounds the goods and is finally detachably connected to another one of the two tightening arms 351. Thus, the goods is securely held to the truck body 10.

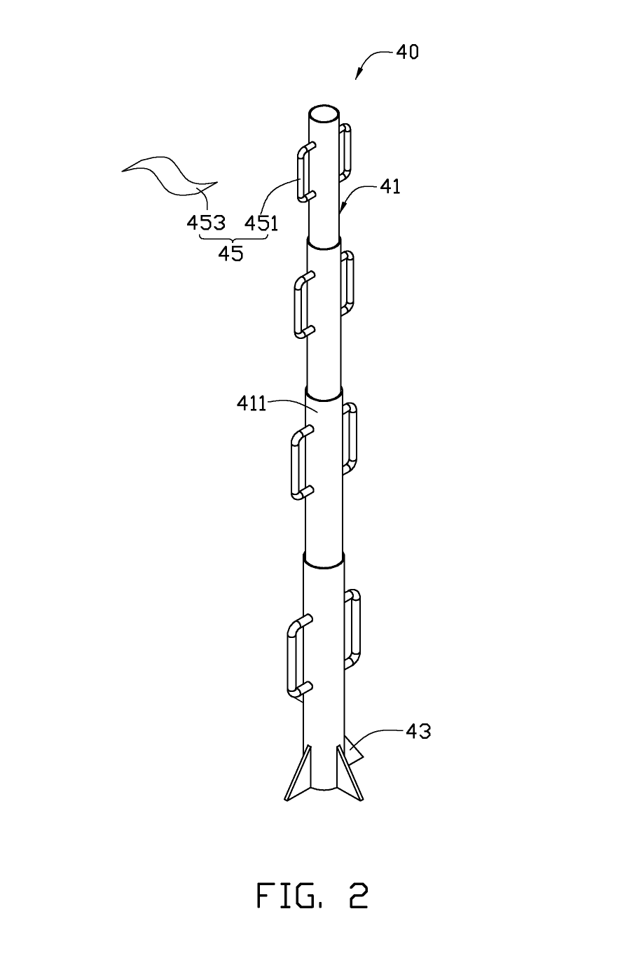

Also referring to FIG. 2, wherein an isometric view of a second embodiment of a tightening device 40 is shown. The tightening device 40 has a structure similar to that of the tightening device 30 of the first embodiment. The tightening device 40 comprises a tightening rod 41, a fixing portion 43 on one end of the tightening rod 41, and a plurality of tightening assemblies 45 separately and axially assembled to the tightening rod 41. Each of the plurality of tightening assemblies 45 comprises two tightening arms 451, and a tightening belt 453. Each of the two tightening arms 451 is substantially U-shapes. The difference between the first and the second embodiments is that the tightening rod 41 has a hollow telescopic structure. The tightening rod 41 comprises a plurality of hollow tubes 411 telescopically connected together one by one. In the illustrated embodiment, the tightening rod 41 is substantially stepped shaft shaped and comprises four hollow telescopic tubes 411 of different diameters.

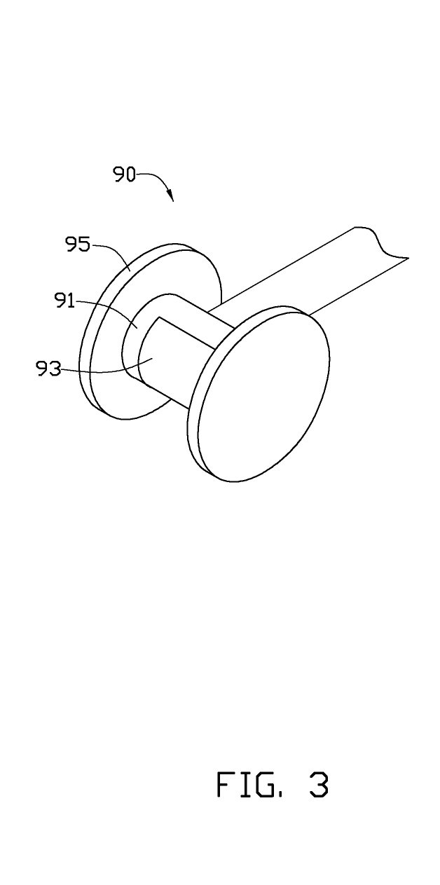

Referring to FIG. 3, wherein an isometric view of another embodiment of a tightening assembly 90 is shown. The tightening assembly 90 comprises a rope barrel 91 which is a hollow cylinder, a tightening rope 93 with one end rotatably coiled around the rope barrel 91 and one free end, and two rolling wheels 95 oppositely and rotatably mounted to two ends of the rope barrel 91. The free end of the tightening rope 93 is exposed to the outside. In use, one of the two rolling wheels 95 of the tightening assembly 90 is fixed to the tightening rod 31 or the tightening rod 41. The free end of the tightening rope 93 may be pulled out to tightly surround the goods and connected to one of the two tightening arms 351 or the two tightening arms 451, thereby by holding and securing the goods to the truck body 10. When in an unused state, the tightening rope 93 is coiled around the rope barrel 91.

The tightening device 30 or the tightening device 40 has a simple structure with small volume, and is easy to operate with excellent tightening capabilities, thereby providing great convenience to the operator. The tightening device 30 or the tightening device 40 may not take up carrying spaces of the truck body 10 since it is mounted on the top surface 115 of the base bracket 11.

It is to be understood, however, that even through numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tightening device applied to a manual fork truck, comprising:
a tightening rod;
a fixing portion on one end of the tightening rod; and
a plurality of tightening assemblies separately assembled to the tightening rod axially; each of the plurality of tightening assemblies comprising at least one tightening arm on the tightening rod, and a tightening belt having one end connected to the at least one tightening arm.

2. The tightening device of claim 1, wherein each of the plurality of tightening assemblies comprises two tightening arms symmetrically projecting from an outer periphery of the tightening rod, and the tightening belt having one end connected to one of the two tightening arms.

3. The tightening device of claim 1, wherein the tightening rod is a hollow cylindrical post made of metallic material.

4. The tightening device of claim 2, wherein the fixing portion comprises a plurality of strengthening rib sheets projecting radially from the outer periphery of a distal end of the tightening rod.

5. The tightening device of claim 1, wherein the tightening rod has a hollow telescopic structure, and comprises a plurality of hollow tubes telescopically connected together one by one.

6. The tightening device of claim 2, wherein the tightening rod is substantially stepped shaft shaped, and comprises a plurality of hollow telescopic tubes of different diameters.

7. The tightening device of claim 1, wherein each of the plurality of tightening assemblies comprises a rope barrel, a tightening rope rotatably coiled around the rope barrel, and two rolling wheels; the rope barrel is a hollow cylinder; each of the two rolling wheels is oppositely and rotatably mounted to each end of the rope barrel; and a free end of the tightening rope is exposed to the outside.

8. A manual fork truck, comprising:
a truck body; and
a tightening device mounted on the truck body, wherein the tightening device holds and secures goods on the truck body, the tightening device comprising:
a tightening rod;
a fixing portion on one end of the tightening rod, and fixed to the truck body; and
a plurality of tightening assemblies separately assembled to the tightening rod axially; each of the plurality of tightening assemblies comprising at least one tightening arm on the tightening rod, and a tightening belt having one end connecting to the at least one tightening arm.

9. The manual fork truck of claim 8, wherein the truck body comprises a base bracket, two pallet forks, two load wheels, a guide wheel, and an operating pusher; the base bracket comprises a first end, a second end opposite to the first end, and a top surface; the fixing portion of the tightening rod is fixedly welded to the top surface of the base bracket; each of the two pallet forks is mounted to the first end of the base bracket, adjacent to a bottom portion of the base bracket; each of the two load wheels is mounted to each of the two pallet forks; the guide wheel is rotatably and adjustably mounted to the second end of the base bracket; and the operating pusher is adjustably hinged to the second end of the base bracket.

10. The manual fork truck of claim 9, wherein each of the plurality of tightening assemblies comprises two tightening arms symmetrically projecting from an outer periphery of the tightening rod, and a tightening belt having one end connected to one of the two tightening arms.

11. The manual fork truck of claim 9, wherein the two pallet forks and the base bracket cooperatively form a carrying space for loading the goods; each of the two pallet forks defines a mounting hole adjacent to a distal end of each of the two pallet forks, and away from the base bracket; each of the two load wheels is oppositely mounted to the bottom portion of each of the two pallet forks; and each of the tow load wheels is partially received within each of the two mounting holes.

12. The manual fork truck of claim 10, wherein the tightening rod is a hollow cylindrical post made of metallic material.

13. The manual fork truck of claim 9, wherein the fixing portion comprises a plurality of strengthening rib sheets projecting radially from the outer periphery of a distal end of the tightening rod.

14. The manual fork truck of claim 9, wherein the tightening rod has a hollow telescopic structure, and comprising a plurality of hollow tubes telescopically connected together one by one.

15. The manual fork truck of claim 10, wherein the tightening rod is substantially stepped shaft shaped, and comprises a plurality of hollow telescopic tubes of different diameters.

16. The manual fork truck of claim 10, wherein each of the plurality of tightening assemblies comprises a rope barrel, a tightening rope rotatably coiled around the rope barrel, and two rolling wheels; the rope barrel is a hollow cylinder; each of the two rolling wheels is oppositely and rotatably mounted to each end of the rope barrel; and a free end of the tightening rope is exposed to the outside.
